(19) United States
(12) Patent Application Publication
(10) Pub. No.: US 2025/0051374 A1
(43) Pub. Date: Feb. 13, 2025

(54) L-GLUFOSINATE DERIVATIVE, COMPOSITION COMPRISING SAME, PREPARATION METHOD THEREFOR AND USE THEREOF

(71) Applicant: LIER CHEMICAL CO., LTD., Mianyang, Sichuan (CN)

(72) Inventors: Lei ZHOU, Chengdu, Sichuan (CN); Yongjiang LIU, Chengdu, Sichuan (CN); Wei ZENG, Chengdu, Sichuan (CN); Min XU, Chengdu, Sichuan (CN); Xiang ZUO, Chengdu, Sichuan (CN); Ke CHENG, Chengdu, Sichuan (CN)

(21) Appl. No.: 18/718,841

(22) PCT Filed: Dec. 12, 2022
(86) PCT No.: PCT/CN2022/138391

§ 371 Date: Jun. 12, 2024

(30) Foreign Application Priority Data
Dec. 13, 2021 (CN) 202111529678.5

(51) Int. Cl. C07F 9/30; C07F 9/32

(52) U.S. Cl. CPC C07F 9/301; C07F 9/3211

(57) ABSTRACT

Provided is a method for preparing the L-glufosinate of formula (I) or a derivative thereof.

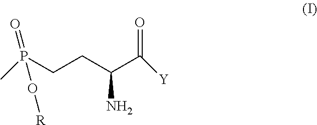

### FIELD OF THE INVENTION

The present invention relates to an L-glufosinate derivative, a composition comprising the same, and preparation method and use thereof.

### BACKGROUND OF THE INVENTION

Glufosinate is a highly potent, broad-spectrum, low toxicity, non-selective (sterilant) organophosphorus herbicide with certain systemic action developed by Hoechst in the 1980s. It can control annual or perennial dicotyledon weeds and gramineae weeds. Glufosinate has two (L- and D-) enantiomers. The herbicidal activity of L-glufosinate is twice as potent as that of racemic DL-glufosinate.

There remains a need to develop glufosinate derivatives to identify compounds with an improved herbicidal effect, reduced drug resistance and/or higher physical/chemical stability during long term storage.

### SUMMARY OF THE INVENTION

The present invention provides a method for preparing a compound of Formula (I),

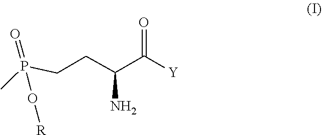

wherein the method comprises reacting a compound of Formula (III) with ROH,

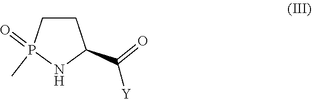

wherein:
Y is —OR₁, —NH₂, —NHR₂, or —N(R₂)(R₃);
R is H, substituted or unsubstituted alkyl having 1-6 carbon atoms, substituted or unsubstituted alkenyl having 2-6 carbon atoms, substituted or unsubstituted alkynyl having 2-6 carbon atoms, substituted or unsubstituted cycloalkyl having 3-10 carbon atoms, substituted or unsubstituted heterocyclyl having 2-10 carbon atoms, substituted or unsubstituted aryl having 6-20 carbon atoms, substituted or unsubstituted aralkyl having 6-20 carbon atoms, or substituted or unsubstituted heteroaryl having 2-10 carbon atoms; preferably, R is H or substituted or unsubstituted alkyl having 1 to 6 carbon atoms; more preferably, R is H (then ROH is water), methyl (then ROH is methanol) or ethyl (then ROH is ethanol);
R₁, R₂ and R₃ are each independently substituted or unsubstituted alkyl having 1-6 carbon atoms, substituted or unsubstituted alkenyl having 2-6 carbon atoms, substituted or unsubstituted alkynyl having 2-6 carbon atoms, substituted or unsubstituted cycloalkyl having 3-10 carbon atoms, substituted or unsubstituted heterocyclyl having 2-10 carbon atoms, substituted or unsubstituted aryl having 6-20 carbon atoms, substituted or unsubstituted aralkyl having 6-20 carbon atoms, or substituted or unsubstituted heteroaryl having 2-10 carbon atoms, or —Si(R₄)(R₅)(R₆);
R₄, R₅ and R₆ are each independently substituted or unsubstituted alkyl having 1-6 carbon atoms, or substituted or unsubstituted aryl having 6-20 carbon atoms;
substituents for the alkyl, alkenyl, alkynyl, cycloalkyl, heterocyclyl, aryl, aralkyl, and heteroaryl groups are each independently halogen, carboxyl (—COOH), amino (—NH₂), nitro (—NO₂), cyano (—CN), alkyl having 1-6 carbon atoms, aryl having 6-10 carbon atoms, or cycloalkyl having 3-10 carbon atoms.

In a preferred embodiment, the reaction between the compound of Formula (III) and ROH is performed at a temperature of from 0° C. to 100° C., e.g., at a temperature of from 0° C. to 80° C., from 0° C. to 60° C., from 0° C. to 40° C., from 0° C. to 30° C., from 0° C. to 20° C., from 30° C. to 80° C., or from 30° C. to 60° C.

The reaction between the compound of Formula (III) and ROH is performed in the absence of an acid and/or a base.

In some embodiments, the compound of Formula (III) is prepared from a compound of Formula (V):

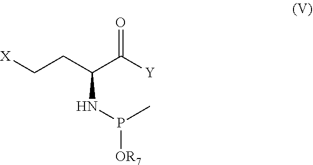

wherein:
X is halogen, —OTs, or Hal

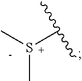

Hal, at each occurrence, is each independently halogen selected from F, Cl, Br or I;
Y is as defined above;
R₇ is H, substituted or unsubstituted alkyl having 1-6 carbon atoms, substituted or unsubstituted alkenyl having 2-6 carbon atoms, or substituted or unsubstituted alkynyl having 2-6 carbon atoms, and substituents for the alkyl, alkenyl and alkynyl groups are each independently halogen, carboxyl, amino, nitro, cyano, alkyl having 1-6 carbon atoms, aryl having 6-10 carbon atoms or cycloalkyl having 3-10 carbon atoms.

In some embodiment, the compound of Formula (V) is prepared by reacting a compound of Formula (II)

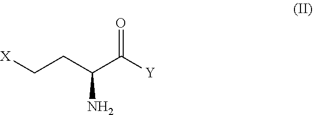

with one or more compounds of Formula (IV) or a mixture;
the mixture being a mixture comprising one or more compounds of Formula (IV)-1 and one or more compounds of Formula (IV)-2; or a mixture comprising one or more compounds of Formula (IV)-1 and one or more compounds of Formula (IV); or a mixture comprising one or more compounds of Formula (IV)-2 and one or more compounds of Formula (IV); or a mixture comprising one or more compounds of Formula (IV), one or more compounds of Formula (IV)-1 and one or more compounds of Formula (IV)-2;

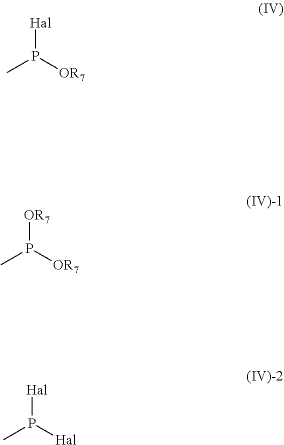

wherein X, Hal and R₇ are as defined above.

In the reaction for preparing the compound of Formula (V), the product can be successfully obtained by any addition order of the starting materials. For example, the compound of Formula (II) is added to the compound of Formula (IV) or the mixture; alternatively, the compound of Formula (IV) or the mixture is added to the compound of Formula (II).

In the reaction for preparing the compound of Formula (V), it can proceed successfully with a salt of the compound of Formula (II) (e.g., a hydrochloride salt).

Further, the above-mentioned R₁, R₂, and R₃ are each independently methyl, ethyl, propyl (e.g., n-propyl, isopropyl), butyl (e.g., n-butyl, isobutyl, or tert-butyl), pentyl, hexyl, benzyl, phenyl or naphthyl, preferably ethyl, n-propyl, isopropyl or n-butyl, more preferably ethyl.

Preferably, Y is —NHCH₂CH₂CH₂CH₃, —N(CH₃)₂, —OCH₃, —OCH₂CH₃, —OCH₂CH₂CH₃, —OCH(CH₃)₂, —OCH₂CH₂CH₂CH₃, —OCH₂CH(CH₃)₂ or —OBn.

Further, the above-mentioned R₇ is methyl, ethyl, propyl, butyl, pentyl or hexyl, preferably ethyl.

Further, in the above-mentioned reaction for preparing the compound of Formula (V), the reaction temperature is −30° C. to 30° C., e.g., −10° C. to 20° C., −10° C. to 10° C., more preferably the temperature is −10° C. The reaction time may be 0.1-20 hours.

Further, in the above-mentioned reaction for preparing the compound of Formula (V), the reaction temperature is −30° C. to 30° C.

Further, in the above-mentioned reaction for preparing the compound of Formula (V), the mixture is a mixture of one or more compounds of Formula (IV)-1 and one or more compounds of Formula (IV), and the molar ratio of the compounds of Formula (IV)-1 to the compounds of Formula (IV) is (0.9-1.1):1 or (0.05-1.1):1; or the mixture is a mixture of one or more compounds of Formula (IV)-2 and one or more compounds of Formula (IV), and the molar ratio of the compounds of Formula (IV)-2 to the compounds of Formula (IV) is (0.9-1.1):1 or (0.05-1.1):1; or the mixture is a mixture comprising one or more compounds of Formula (IV)-1 and one or more compounds of Formula (IV)-2, and the molar ratio of the compounds of Formula (IV)-1 to the compounds of Formula (IV)-2 is (0.9-1.1):1.

Further, the above-mentioned reaction for preparing the compound of Formula (V) is performed in the presence of a base.

Further, the base employed in the above-mentioned reaction for preparing the compound of Formula (V) is an organic base or ammonia.

Further, in the above-mentioned reaction for preparing the compound of Formula (V), the organic base is selected from the group consisting of organic amine, pyridine or a pyridine derivative having 1-3 substituents attached to one or more carbon atoms in the heterocycle, piperidine or a piperidine derivative having 1-3 substituents attached to one or more carbon atoms in the heterocycle;

preferably, the above substituents are selected from the group consisting of halogen, —OH, —O—(C₁-C₆ alkyl), —NH₂, —NO₂, —CN, C₁-C₆ alkyl, C₃₋₁₀ cycloalkyl and C₆₋₁₀ aryl.

Further, in the above-mentioned reaction for preparing the compound of Formula (V), the organic base is selected from the group consisting of N,N-dimethylaniline, triethylamine, piperidine or pyridine.

Further, the above-mentioned reaction for preparing the compound of Formula (V) is carried out under a solvent-free condition or in an inert solvent; the inert solvent is selected from any one or more of benzene solvents, amide solvents, hydrocarbon solvents, halogenated hydrocarbon solvents, sulfone or sulfoxide solvents, ether solvents or ester solvents; preferably, the inert solvent is selected from any one or more of benzene solvents, amide solvents, halogenated hydrocarbon solvents, ether solvents or ester solvents.

Further, the inert solvent is selected from any one or more of chlorobenzene, trimethylbenzene, 1,4-dioxane, 1,2-dichloroethane, dimethyl sulfoxide, N-methylpyrrolidone, N,N-dimethylformamide, petroleum ether, n-heptane, tetrahydrofuran, methyltetrahydrofuran, benzene, toluene, ethyl acetate, and butyl acetate.

Further, in the above-mentioned reaction for preparing the compound of Formula (V), the molar ratio of the compound of Formula (IV) or the mixture to the compound of Formula (II) is 1:(0.5-10), preferably 1:(1-3); or the molar ratio of the compound of Formula (II) to the compound of Formula (IV) or the mixture is 1:(0.5-10), preferably 1:(1-3). A slight excess of the compound of Formula (IV) or the mixture is advantageous for the yield of the reaction, e.g., an excess of 5% to 10%.

Further, the above-mentioned reaction for preparing the compound of Formula (III) comprises heating the compound of Formula (V) at a temperature of 50° C. to 150° C. to convert to the compound of Formula (III). Preferred temperature is 60° C. to 120° C. or 90° C. to 100° C. The reaction time may be 0.5-40 hours.

In some embodiments, the reaction for preparing the compound of Formula (III) may be performed in the presence of an organic solvent such as 1,4-dioxane, acetonitrile, 1,2-dichloroethane, tetrahydrofuran, chlorobenzene, and a more preferred organic solvent is chlorobenzene.

Further, the above-mentioned reaction for preparing the compound of Formula (V) and the reaction for preparing the compound of Formula (III) are a one-pot process, i.e., without isolating the intermediate compound of Formula (V).

Further, the above-mentioned compound of Formula (I) has an enantiomeric excess (ee) value of greater than 50%.

Further, the above-mentioned compound of Formula (I) has an ee value of greater than 90%.

### Definitions

Unless otherwise defined, all technical and scientific terms used herein are intended to have the same meaning as commonly understood by a person skilled in the art. References to techniques employed herein are intended to refer to the techniques as commonly understood in the art, including variations on those techniques or substitutions of equivalent techniques which would be apparent to a person skilled in the art. While it is believed that the following terms will be readily understood by a person skilled in the art, the following definitions are nevertheless put forth to better illustrate the present invention.

As used herein, the terms “contain”, “include”, “comprise”, “have”, or “relate to”, as well as other variations used herein are inclusive or open-ended, and do not exclude additional, unrecited elements or method steps.

As used herein, the term “alkyl” is defined as linear or branched saturated aliphatic hydrocarbon. In some embodiments, alkyl has 1-12, e.g., 1-6 carbon atoms. For example, as used herein, the term “alkyl having 1-6 carbon atoms” refers to a linear or branched group having 1-6 carbon atoms (such as methyl, ethyl, n-propyl, isopropyl, n-butyl, isobutyl, sec-butyl, tert-butyl, n-amyl, isoamyl, neoamyl, or n-hexyl), which is optionally substituted with one or more (e.g., 1 to 3) suitable substituents such as halogen (at this time, this group is referred to as “haloalkyl”) (e.g., CH₂F, CHF₂, CF₃, CCl₃, C₂F₅, C₂Cl₅, CH₂CF₃, CH₂Cl or —CH₂CH₂CF₃ etc.). The term “alkyl having 1-4 carbon atoms” refers to a linear or branched aliphatic hydrocarbon chain having 1-4 carbon atoms (i.e., methyl, ethyl, n-propyl, isopropyl, n-butyl, isobutyl, sec-butyl or tert-butyl).

As used herein, the term “alkenyl” refers to a linear or branched monovalent hydrocarbyl containing one or more double bonds and having 2 to 6 carbon atoms (“C₂₋₆ alkenyl”). The alkenyl is, for example, vinyl, 1-propenyl, 2-propenyl, 2-butenyl, 3-butenyl, 2-pentenyl, 3-pentenyl, 4-pentenyl, 2-hexenyl, 3-hexenyl, 4-hexenyl, 5-hexenyl, 2-methyl-2-propenyl and 4-methyl-3-pentenyl. When the compound of the present invention contains an alkenyl group, the compound may exist as the pure E (entgegen) form, the pure Z (zusammen) form, or any mixture thereof.

As used herein, the term “alkynyl” represents a monovalent hydrocarbyl containing one or more triple bonds and preferably having 2, 3, 4, 5 or 6 carbon atoms, for example, an ethynyl or propynyl.

As used herein, the term “cycloalkyl” refers to a saturated monocyclic or polycyclic (e.g., bicyclic) hydrocarbon ring (e.g., monocyclic, such as cyclopropyl, cyclobutyl, cyclopentyl, cyclohexyl, cycloheptyl, cyclooctyl, cyclononyl, or bicyclic, including spiro, fused or bridged cyclic system (such as bicyclo[1.1.1]pentyl, bicyclo[2.2.1]heptyl, bicyclo[3.2.1]octyl or bicyclo[5.2.0]nonyl, decahydronaphthalene, etc.)), which is optionally substituted with one or more (e.g., 1 to 3) suitable substituents. The cycloalkyl preferably has 3 to 10 carbon atoms. For example, the term “C₃₋₆ cycloalkyl” refers to a saturated monocyclic or polycyclic (e.g., bicyclic) hydrocarbon ring having 3 to 6 ring forming carbon atoms (e.g., cyclopropyl, cyclobutyl, cyclopentyl, or cyclohexyl), which is optionally substituted with one or more (e.g., 1 to 3) suitable substituents, e.g., methyl substituted cyclopropyl.

As used herein, the term “heterocyclyl” refers to a saturated or unsaturated, monovalent, monocyclic or bicyclic residue having 2, 3, 4, 5, 6, 7, 8, 9 or 10 carbon atoms and one or more (e.g., 1, 2, 3 or 4) heteroatom-containing groups selected from the group consisting of C(═O), O, S, S(═O), S(═O)₂, and NR^{d} wherein R^{d} represents a hydrogen atom, or C₁₋₆ alkyl, or C₁₋₆ haloalkyl group, in the ring. A heterocyclyl may be linked to the rest of a molecule through any one of the carbon atoms or a nitrogen atom (if present). In particular, a heterocyclyl having 2 to 10 carbon atoms is for example, but is not limited to, oxiranyl, aziridinyl, azetidinyl, oxetanyl, tetrahydrofuranyl, dioxolinyl, pyrrolidinyl, pyrrolidinonyl, imidazolidinyl, pyrazolidinyl, pyrrolinyl, tetrahydropyranyl, piperidinyl, morpholinyl, dithianyl, thiomorpholinyl, piperazinyl or trithianyl.

As used herein, the term “aryl” refers to an all-carbon monocyclic or fused-ring polycyclic aromatic group having a conjugated 21 electron system. For example, as used herein, the term “aryl having 6-20 carbon atoms” refers to an aromatic group containing 6 to 20 carbon atoms, such as phenyl or naphthyl. Aryl is optionally substituted with one or more (such as 1 to 3) suitable substituents (e.g., halogen, —OH, —CN, —NO₂, and C₁₋₆ alkyl).

As used herein, the term “aralkyl” preferably means aryl substituted alkyl, wherein the aryl and alkyl are as defined herein. Normally, the aryl group may have 6-10 carbon atoms, and the alkyl group may have 1-6 carbon atoms. Exemplary aralkyl group includes, but is not limited to, benzyl, phenylethyl, phenylpropyl, phenylbutyl.

As used herein, the term “heteroaryl” refers to a monovalent monocyclic, bicyclic or tricyclic aromatic ring system having 5, 6, 8, 9, 10, 11, 12, 13 or 14 ring atoms, particularly 1 or 2 or 3 or 4 or 5 or 6 or 9 or 10 carbon atoms, and containing at least one heteroatom (such as 0, N, or S), which can be same or different. Moreover, in each case, it can be benzo-fused. In particular, heteroaryl is selected from the group consisting of thienyl, furyl, pyrrolyl, oxazolyl, thiazolyl, imidazolyl, pyrazolyl, isoxazolyl, isothiazolyl, oxadiazolyl, triazolyl, thiadiazolyl etc., and benzo derivatives thereof; or pyridinyl, pyridazinyl, pyrimidinyl, pyrazinyl, triazinyl, etc., and benzo derivatives thereof.

As used herein, the term “halogen” is defined to include F, Cl, Br, or I.

As used herein, the term “substituted” means that one or more (e.g., one, two, three, or four) hydrogens on a designated atom is replaced with a selection from the indicated group, provided that the designated atom's normal valency under the existing circumstances is not exceeded, and that the substitution results in a stable compound. Combinations of substituents and/or variables are permissible only if such combinations result in stable compounds.

### DETAILED DESCRIPTION OF THE INVENTION

Chlorohomoserine alkyl esters used in the following examples may be prepared by a method similar to that disclosed in CN 110845347 A. The remaining reagents (e.g., MDP and MDEP) are all commercially available.

The product content recited in the examples is the absolute content of the pure product in the product obtained, which was determined by HPLC (an external standard method).

### Example 1

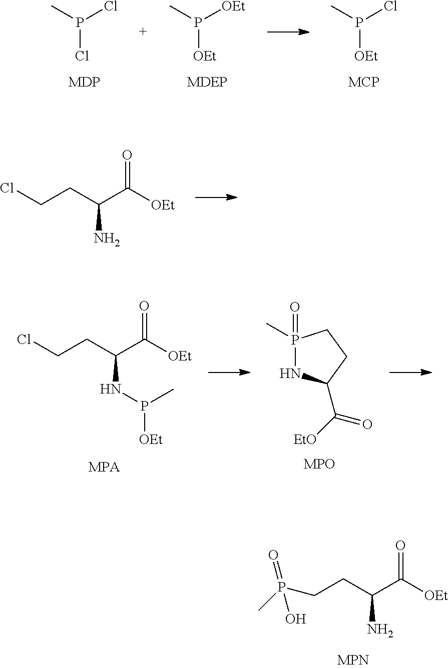

A solution of diethyl methylphosphonite (MDEP, 68.8 g, 455.4 mmol, 0.53 eq, and a purity of 90%) in chlorobenzene (300 g) was added to a round-bottom flask under nitrogen atmosphere at −10° C., and a solution of dichloro(methyl)phosphane (MDP, 54.4 g, 455.4 mmol, 0.53 eq, and a purity of 98%) in chlorobenzene (200 g) was added dropwise through a constant-pressure funnel at a dripping rate of 1 d/s. After the dropwise addition was completed, stirring was continued for 10 minutes (MCP was generated in the reaction solution at this time). A solution of chlorohomoserine ethyl ester (150 g, 867.5 mmol, 1.0 eq, a purity of 96%, and an ee value of 99%) and triethylamine (107.5 g, 1041 mmol, 1.2 eq, and a purity of 98%) in chlorobenzene (500 g) was added dropwise thereto at a dripping rate of 4 d/s. After the dropwise addition was completed, stirring was continued for 30 minutes. The reaction was then warmed to room temperature and stirred for 1 hour, followed by reaction at 90° C. for 3 h until complete reaction. The mixture was naturally cooled to room temperature, and filtered with suction. The filter cake was washed with chlorobenzene (150 mL×3), and the filtrate was rotary evaporated to remove chlorobenzene, thereby obtaining a pale yellow viscous liquid, which is the crude MPO product.

A mixture of water (62.5 g, 3470 mmol) and acetonitrile (125 g) was added dropwise to the crude MPO product at 10° C. The reaction was stirred for 1 h until a solid precipitated out. Acetonitrile (594 g) was then added, and the solution was stirred at room temperature (about 15° C.) until a large amount of solid precipitated out. The solid was filtered and dried to afford MPN (white solid, 145.9 g, content: 90%).

Data for characterizing the structure of the product are shown below:
MS (ESI): m/z [M+H]⁺ calcd for C7H17NO4P: 210.09; found: 210.1.
¹H NMR (400 MHz, DMSO-d₆) δ: 4.34-4.11 (m, 2H), 4.00 (t, J=5.8 Hz, 1H), 2.28-1.92 (m, 2H), 1.77-1.48 (m, 2H), 1.23 (t, J=7.1 Hz, 3H), 1.17 (d, J=13.8 Hz, 3H).
¹³C NMR (100 MHz, DMSO-d₆) δ 169.5, 61.7, 52.4, 52.3, 27.6, 26.7, 23.8, 16.3, 15.3, 14.0.
³¹P NMR (160 MHz, DMSO-d₆) δ 38.9.

### Example 2

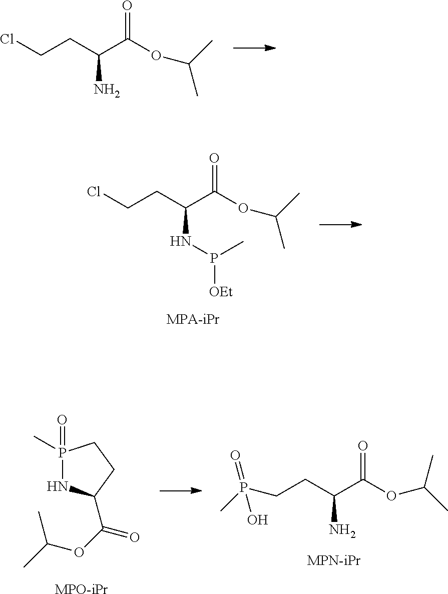

A solution of diethyl methylphosphite (MDEP, 34.7 g, 227.6 mmol, 0.53 eq, and a purity of 90%) in chlorobenzene (300 g) was added to a round-bottomed flask under nitrogen atmosphere at −10° C., and a solution of dichloro(methyl)phosphane (MDP, 27.2 g, 227.6 mmol, 0.53 eq, and a purity of 98%) in chlorobenzene (200 g) was added dropwise through a constant-pressure funnel at a dripping rate of 1 d/s. After the dropwise addition was completed, stirring was continued for 10 min (MCP was generated in the reaction solution at this time). A solution of chlorohomoserine isopropyl ester (82.0 g, 433.6 mmol, 1.0 eq, a purity of 95%, and an ee value of 99%) and triethylamine (53.8 g, 520.5 mmol, 1.2 eq, and a purity of 98%) in chlorobenzene (300 g) was added dropwise thereto at a dripping rate of 4 d/s. After the dropwise addition was completed, stirring was continued for 30 minutes. The reaction was then warmed to room temperature and stirred for 1 hour, followed by reaction at 90° C. for 3 h until complete reaction. The mixture was naturally cooled to room temperature, and filtered with suction. The filter cake was washed with chlorobenzene (150 mL×3), and the filtrate was rotary evaporated to remove chlorobenzene, thereby obtaining a pale yellow viscous liquid, which is the crude MPO-iPr product.

A mixture of water (31.2 g, 1734.4 mmol) and acetonitrile (62.4 g) was added dropwise to the crude MPO-iPr product at 10° C. The reaction was stirred for 1 h until a solid precipitated out. Acetonitrile (296.4 g) was then added, and the solution was stirred at room temperature (about 15° C.) until a large amount of solid precipitated out. The solid was filtered and dried to afford MPN-iPr (white solid, 79.4 g, content: 91%).

Data for characterizing the structure of the product are shown below:
MS (ESI): m/z [M+H]⁺ calcd for C8H19NO4P: 224.10; found: 224.1.
¹H NMR (600 MHz, Chloroform-d) δ 5.10 (p, J=6.3 Hz, 1H), 3.82 (dd, J=7.5, 2.9 Hz, 1H), 2.41-2.31 (m, 1H), 2.26 (dddq, J=15.6, 11.9, 8.0, 4.5, 4.0 Hz, 1H), 1.77-1.60 (m, 2H), 1.31-1.23 (m, 9H).
¹³C NMR (150 MHz, Chloroform-d) δ 169.2, 70.0, 53.1, 29.1, 28.5, 23.8, 21.9, 17.1, 16.5.
³¹P NMR (240 MHz, Chloroform-d) δ 36.8.

### Example 3

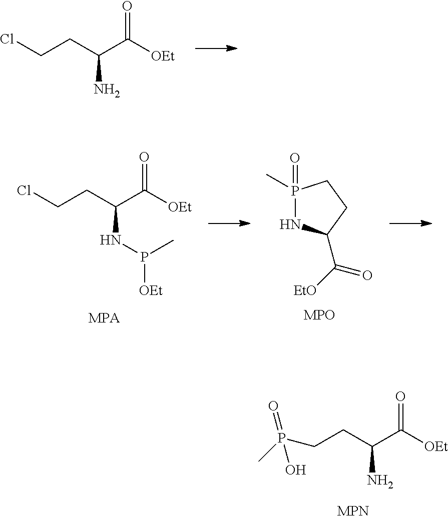

A solution of diethyl methylphosphonite (MDEP, 22.9 g, 151.8 mmol, 0.53 eq, and a purity of 90%) in chlorobenzene (100 g) was added to a round-bottom flask under nitrogen atmosphere at −10° C., and a solution of dichloro(methyl)phosphane (MDP, 18.1 g, 151.8 mmol, 0.53 eq, and a purity of 98%) in chlorobenzene (67 g) was added dropwise through a constant-pressure funnel at a dripping rate of 1 d/s. After the dropwise addition was completed, stirring was continued for 10 minutes (MCP was generated in the reaction solution at this time). A solution of chlorohomoserine ethyl ester (50 g, 289.1 mmol, 1.0 eq, a purity of 96%, and an ee value of 99%) and triethylamine (35.8 g, 347.0 mmol, 1.2 eq, and a purity of 98%) in chlorobenzene (167 g) was added dropwise thereto at a dripping rate of 4 d/s. After the dropwise addition was completed, stirring was continued for 30 minutes. The reaction was then warmed to room temperature and stirred for 1 hour, followed by reaction at 90° C. for 3 h until complete reaction. The mixture was naturally cooled to room temperature, and filtered with suction. The filter cake was washed with chlorobenzene (50 mL×3).

A mixture of water (20.8 g, 1156.4 mmol) and acetonitrile (20.8 g) was added to the MPO filtrate, and the mixture was rotary evaporated until a solid precipitated out. The rotary evaporation was stopped, acetonitrile (250 g) containing 5% by weight of water was added, the mixture was stirred, and a large amount of solid precipitated out. The solid was filtered and dried to afford MPN (a white solid, 41.8 g, content: 94%).

### Example 4

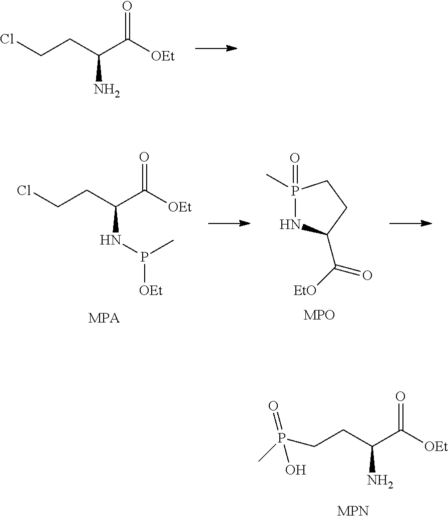

A solution of diethyl methylphosphonite (MDEP, 22.9 kg, and a purity of 95%) in chlorobenzene (80 kg) was added to a reactor under nitrogen atmosphere at −10° C. to −15° C., and dichloro(methyl)phosphane (MDP, 19.1 kg, and a purity of 98%) was added dropwise over 2 h. After the dropwise addition was completed, stirring was continued for 30 minutes (MCP was generated in the reaction solution at this time). The reaction solution was added dropwise to a solution of chlorohomoserine ethyl ester (50 kg, a purity of 96%, and an ee value of 99%) and triethylamine (35.8 kg, and a purity of 98%) in chlorobenzene (232 kg) over 5 h. After the dropwise addition was completed, the reaction was warmed to 90° C. and allowed to proceed for 3 h until complete reaction. The mixture was naturally cooled to room temperature and centrifuged. The filter cake was thoroughly washed with chlorobenzene.

A mixture of water (10 kg) and acetonitrile (20 kg) was added to the MPO filtrate at 60° C., the mixture was stirred for 30 minutes and then the solvent was distilled until a solid precipitated out. Acetonitrile (25 kg) containing 5% by weight of water was added, the mixture was stirred, and a large amount of solid precipitated out. The solid was filtered and dried to afford MPN (a white solid, 57.5 kg, content: 96%, yield 91%, ee 99%), the MPN remained in the mother liquor was 3.2%.

### Example 5

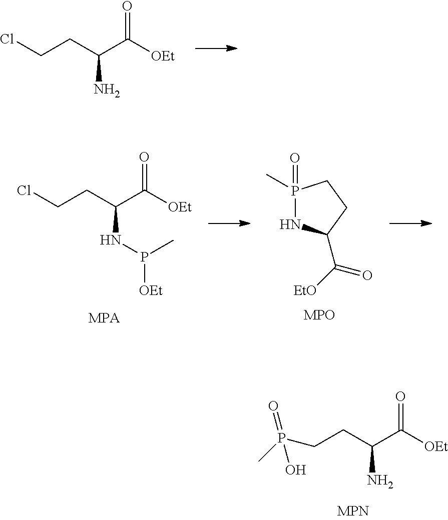

A solution of diethyl methylphosphonite (MDEP, 11.5 kg, and a purity of 95%) in chlorobenzene (40 kg) was added to a reactor under nitrogen atmosphere at −10° C. to −15° C., and dichloro(methyl)phosphane (MDP, 10.1 kg, and a purity of 98%) was added dropwise over 1 h. After the dropwise addition was completed, stirring was continued for 30 minutes (MCP was generated in the reaction solution at this time). The reaction solution was added dropwise to a solution of chlorohomoserine ethyl ester (25 kg, a purity of 96%, and an ee value of 99%) in chlorobenzene (232 kg) over 3 h, while 3 kg ammonia gas was pumped in for neutralization. After the dropwise addition was completed, the reaction was warmed to 90° C. and allowed to proceed for 3 h until complete reaction. The mixture was naturally cooled to room temperature and centrifuged. The filter cake was thoroughly washed with chlorobenzene.

A mixture of water (5 kg) and acetonitrile (25 kg) was added to the MPO filtrate at 40° C., the mixture was stirred for 30 minutes and then the solvent was distilled until a large amount of solid precipitated out. The solid was filtered and dried to afford MPN (a white solid, 28.1 kg, content: 96%, yield 89%, ee 99%), the MPN remained in the mother liquor was 2.8%.

### Example 6

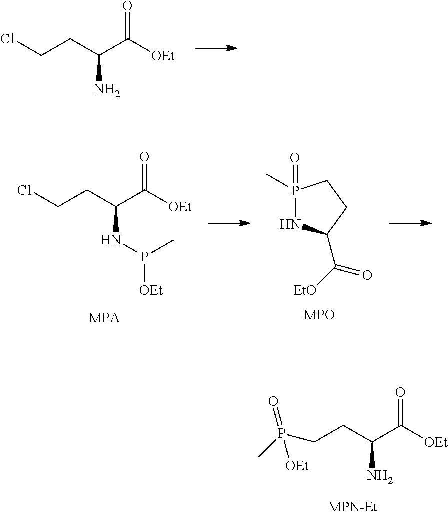

A solution of diethyl methylphosphonite (MDEP, 22.9 g, 151.8 mmol, 0.53 eq, and a purity of 90%) in chlorobenzene (100 g) was added to a round-bottom flask under nitrogen atmosphere at −10° C., and a solution of dichloro(methyl)phosphane (MDP, 18.1 g, 151.8 mmol, 0.53 eq, and a purity of 98%) in chlorobenzene (67 g) was added dropwise through a constant-pressure funnel at a dripping rate of 1 d/s. After the dropwise addition was completed, stirring was continued for 10 minutes (MCP was generated in the reaction solution at this time). A solution of chlorohomoserine ethyl ester (50 g, 289.1 mmol, 1.0 eq, a purity of 96%, and an ee value of 99%) and triethylamine (35.8 g, 347.0 mmol, 1.2 eq, and a purity of 98%) in chlorobenzene (167 g) was added dropwise thereto at a dripping rate of 4 d/s. After the dropwise addition was completed, stirring was continued for 30 minutes. The reaction was then warmed to room temperature and stirred for 1 hour, followed by reaction at 90° C. for 3 h until complete reaction. The mixture was naturally cooled to room temperature, and filtered with suction. The filter cake was washed with chlorobenzene (50 mL×3).

Absolute ethanol (40 g, 867.3 mmol) was added to the MPO filtrate at 10° C. The reaction was stirred for 1 h and distilled under reduced pressure to afford MPN-Et (a pale yellow viscous liquid, 76.8 g, content: 75%, yield 84%, ee 98.7%).

### Example 7

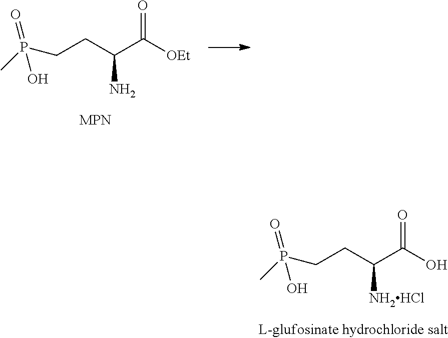

MPN (70 g, 301.2 mmol, a purity of 90%) was added to a round-bottom flask, and 36% concentrated hydrochloric acid (315 mL) was added dropwise. The reaction was slowly heated to reflux until complete reaction of the starting materials. The solvent was evaporated to dryness, 95% ethanol (240 mL) and water (24 mL) were added, and the mixture was refluxed until the product is completely dissolved. The solution was cooled to allow precipitation of the solid. The solid was filtered and dried to afford the L-glufosinate hydrochloride salt (a white solid, yield of the pure product 92.4%, content 96.6%, an ee value of 98%).

### Example 8

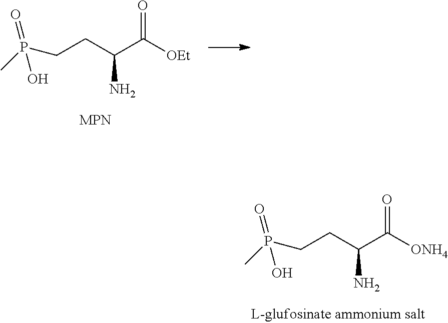

MPN (70 g, 301.2 mmol, a purity of 90%) was added to a round-bottom flask, and 36% concentrated hydrochloric acid (315 mL) was added dropwise. The reaction was slowly heated to reflux until complete reaction of the starting materials. The solvent was evaporated to dryness, water (63 g) was added, followed by dropwise addition of ammonia water (59 g) to adjust the pH to 7-8. The solvent was then evaporated to dryness, the residue was dissolved by adding methanol, filtered to remove ammonium chloride, and the filtrate was refluxed for 2 h. The mixture was cooled to 15° C. to allow precipitation of the solid. The solid was filtered and dried to afford the L-glufosinate ammonium salt (a white solid, yield of the pure product 84.4%, content 96%, an ee value of 98%).

### Example 9

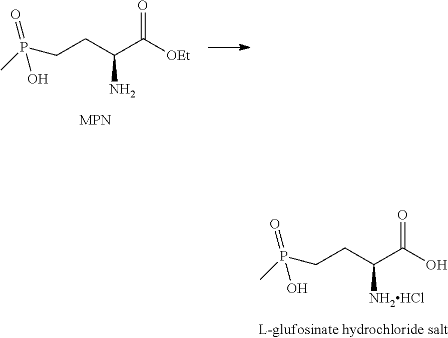

MPN-Et (70 g, 221.4 mmol, a purity of 75%) was added to a round-bottom flask, and 36% concentrated hydrochloric acid (315 mL) was added dropwise. The reaction was slowly heated to reflux until complete reaction of the starting materials. The solvent was evaporated to dryness, 95% ethanol (200 mL) and water (20 mL) were added, and the mixture was refluxed until the product is completely dissolved. The solution was cooled to allow precipitation of the solid. The solid was filtered and dried to afford the L-glufosinate hydrochloride salt (a white solid, yield of the pure product 91.3%, content 93.2%, an ee value of 97%).

### Example 10

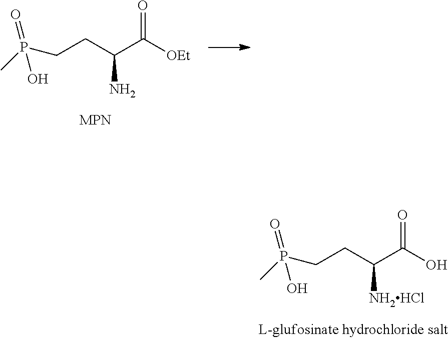

MPN (28.7 kg, and a purity of 96%) was added to a reactor, and 30% concentrated hydrochloric acid (143.5 kg) was added. The reaction was slowly heated to 100° C. and allowed to proceed at this temperature while being distilled. Upon complete reaction of the starting materials, the solvent was evaporated to dryness, 95% ethanol (72 kg) was added, and the mixture was stirred. Upon cooling, a large amount of solid precipitated out. The solid was filtered and dried to afford the L-glufosinate hydrochloride salt (a white solid, 28.4 kg, yield of the pure product 91.7%, content 96.2%, an ee value of 99%), the amount of the L-glufosinate hydrochloride salt remained in the mother liquor was 3.6%.

In addition to those described herein, according to the foregoing description, various modifications to the present invention would be apparent to those skilled in the art. Such modifications are intended to fall within the scope of the appended claims. Each reference cited herein (including all patents, patent applications, journal articles, books and any other disclosures) are incorporated herein by reference in its entirety.

1. A method for preparing a compound of Formula (I), 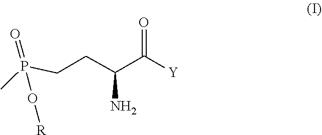
wherein the method comprises reacting a compound of Formula (III) with ROH, 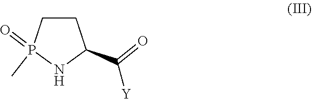
wherein:
Y is —OR₁, —NH₂, —NHR₂, or —N(R₂)(R₃);
R is H, substituted or unsubstituted alkyl having 1-6 carbon atoms, substituted or unsubstituted alkenyl having 2-6 carbon atoms, substituted or unsubstituted alkynyl having 2-6 carbon atoms, substituted or unsubstituted cycloalkyl having 3-10 carbon atoms, substituted or unsubstituted heterocyclyl having 2-10 carbon atoms, substituted or unsubstituted aryl having 6-20 carbon atoms, substituted or unsubstituted aralkyl having 6-20 carbon atoms, or substituted or unsubstituted heteroaryl having 2-10 carbon atoms; preferably, R is H or substituted or unsubstituted alkyl having 1 to 6 carbon atoms; more preferably, R is H, methyl or ethyl;
R₁, R₂ and R₃ are each independently substituted or unsubstituted alkyl having 1-6 carbon atoms, substituted or unsubstituted alkenyl having 2-6 carbon atoms, substituted or unsubstituted alkynyl having 2-6 carbon atoms, substituted or unsubstituted cycloalkyl having 3-10 carbon atoms, substituted or unsubstituted heterocyclyl having 2-10 carbon atoms, substituted or unsubstituted aryl having 6-20 carbon atoms, substituted or unsubstituted aralkyl having 6-20 carbon atoms, or substituted or unsubstituted heteroaryl having 2-10 carbon atoms, or —Si(R₄)(R₅)(R₆);
R₄, R₅ and R₆ are each independently substituted or unsubstituted alkyl having 1-6 carbon atoms, or substituted or unsubstituted aryl having 6-20 carbon atoms;
substituents for the alkyl, alkenyl, alkynyl, cycloalkyl, heterocyclyl, aryl, aralkyl, and heteroaryl groups are each independently halogen, carboxyl, amino, nitro, cyano, alkyl having 1-6 carbon atoms, aryl having 6-10 carbon atoms, or cycloalkyl having 3-10 carbon atoms.

2. The method according to claim 1, wherein the compound of Formula (III) is prepared from a compound of Formula (V): 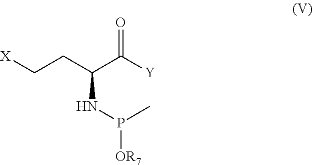
wherein:
X is halogen, —OTs, or Hal 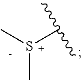
Hal, at each occurrence, is each independently halogen selected from F, Cl, Br or I;
Y is as defined in claim 1;
R₇ is H, substituted or unsubstituted alkyl having 1-6 carbon atoms, substituted or unsubstituted alkenyl having 2-6 carbon atoms, or substituted or unsubstituted alkynyl having 2-6 carbon atoms, and substituents for the alkyl, alkenyl and alkynyl groups are each independently halogen, carboxyl, amino, nitro, cyano, alkyl having 1-6 carbon atoms, aryl having 6-10 carbon atoms or cycloalkyl having 3-10 carbon atoms.

3. The method according to claim 2, wherein the compound of Formula (V) is prepared by reacting a compound of Formula (II) 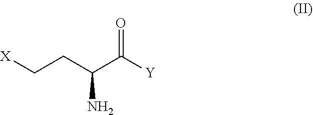
with one or more compounds of Formula (IV) or a mixture;
the mixture being a mixture comprising one or more compounds of Formula (IV)-1 and one or more compounds of Formula (IV)-2; or a mixture comprising one or more compounds of Formula (IV)-1 and one or more compounds of Formula (IV); or a mixture comprising one or more compounds of Formula (IV)-2 and one or more compounds of Formula (IV); or a mixture comprising one or more compounds of Formula (IV), one or more compounds of Formula (IV)-1 and one or more compounds of Formula (IV)-2; 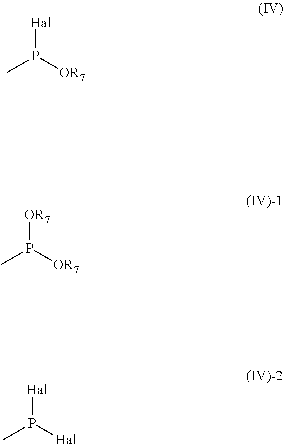
wherein X, Hal and R₇ are as defined in claim 2.

4. The method according to claim 1, wherein R₁, R₂, and R₃ are each independently methyl, ethyl, propyl (e.g., n-propyl, isopropyl), butyl (e.g., n-butyl, isobutyl, or tert-butyl), pentyl, hexyl, benzyl, phenyl or naphthyl, preferably ethyl, n-propyl, isopropyl or n-butyl, more preferably ethyl;
preferably, Y is —NHCH₂CH₂CH₂CH₃, —N(CH₃)₂, —OCH₃, —OCH₂CH₃, —OCH₂CH₂CH₃, —OCH(CH₃)₂, —OCH₂CH₂CH₂CH₃, —OCH₂CH(CH₃)₂ or —OBn.

5. The method according to claim 2, wherein R₇ is methyl, ethyl, propyl, butyl, pentyl or hexyl, preferably ethyl.

6. The method according to claim 3, wherein in the reaction for preparing the compound of Formula (V), the reaction temperature is −30° C. to 30° C.

7. The method according to claim 3, wherein in the reaction for preparing the compound of Formula (V), the mixture is a mixture of one or more compounds of Formula (IV)-1 and one or more compounds of Formula (IV), and the molar ratio of the compounds of Formula (IV)-1 to the compounds of Formula (IV) is (0.9-1.1):1 or (0.05-1.1):1; or the mixture is a mixture of one or more compounds of Formula (IV)-2 and one or more compounds of Formula (IV), and the molar ratio of the compounds of Formula (IV)-2 to the compounds of Formula (IV) is (0.9-1.1):1 or (0.05-1.1):1; or the mixture is a mixture comprising one or more compounds of Formula (IV)-1 and one or more compounds of Formula (IV)-2, and the molar ratio of the compounds of Formula (IV)-1 to the compounds of Formula (IV)-2 is (0.9-1.1):1.

8. The method according to claim 3, wherein the reaction for preparing the compound of Formula (V) is performed in the presence of a base.

9. The method according to claim 8, wherein the base employed in the reaction for preparing the compound of Formula (V) is an organic base or ammonia.

10. The method according to claim 9, wherein in the reaction for preparing the compound of Formula (V), the organic base is selected from the group consisting of organic amine, pyridine or a pyridine derivative having 1-3 substituents attached to one or more carbon atoms in the heterocycle, piperidine or a piperidine derivative having 1-3 substituents attached to one or more carbon atoms in the heterocycle;
preferably, the above substituents are selected from the group consisting of halogen, —OH, —O—(C₁-C₆ alkyl), —NH₂, —NO₂, —CN, C₁-C₆ alkyl, C₃₋₁₀ cycloalkyl and C₆₋₁₀ aryl.

11. The method according to claim 10, wherein the organic base is selected from the group consisting of N,N-dimethylaniline, triethylamine, piperidine or pyridine.

12. The method according to claim 3, wherein the reaction for preparing the compound of Formula (V) is carried out under a solvent-free condition or in an inert solvent; the inert solvent is selected from any one or more of benzene solvents, amide solvents, hydrocarbon solvents, halogenated hydrocarbon solvents, sulfone or sulfoxide solvents, ether solvents or ester solvents; preferably, the inert solvent is selected from any one or more of benzene solvents, amide solvents, halogenated hydrocarbon solvents, ether solvents or ester solvents.

13. The method according to claim 12, wherein the inert solvent is selected from any one or more of chlorobenzene, trimethylbenzene, 1,4-dioxane, 1,2-dichloroethane, dimethyl sulfoxide, N-methylpyrrolidone, N,N-dimethylformamide, petroleum ether, n-heptane, tetrahydrofuran, methyltetrahydrofuran, benzene, toluene, ethyl acetate, and butyl acetate.

14. The method according to claim 3, wherein in the reaction for preparing the compound of Formula (V), the molar ratio of the compound of Formula (IV) or the mixture to the compound of Formula (II) is 1:(0.5-10), preferably 1:(1-3); or the molar ratio of the compound of Formula (II) to the compound of Formula (IV) or the mixture is 1:(0.5-10), preferably 1:(1-3).

15. The method according to claim 2, wherein the reaction for preparing the compound of Formula (III) comprises heating the compound of Formula (V) at a temperature of 50° C. to 150° C.

16. The method according to claim 3, wherein the reaction for preparing the compound of Formula (V) and the reaction for preparing the compound of Formula (III) are a one-pot process.

17. The method according to claim 1, wherein the compound of Formula (I) has an enantiomeric excess (ee) value of greater than 50%.

18. The method according to claim 17, wherein the compound of Formula (I) has an ee value of greater than 90%.

19. The method according to claim 1, wherein the reaction between the compound of Formula (III) and ROH is performed at a temperature of from 0° C. to 100° C., e.g., at a temperature of from 0° C. to 80° C., from 0° C. to 60° C., from 0° C. to 40° C., from 0° C. to 30° C., from 0° C. to 20° C., from 30° C. to 80° C., or from 30° C. to 60° C.
